(19) United States
(12) Patent Application Publication
(10) Pub. No.: US 2011/0186560 A1
(43) Pub. Date: Aug. 4, 2011

(54) VENTILATED SEAT ASSEMBLY AND A METHOD OF CONTROL

(75) Inventors: Karl Kennedy, Evans City, PA (US); John F. Nathan, Highland Township, MI (US)

(73) Assignee: LEAR CORPORATION, Southfield, MI (US)

(21) Appl. No.: 13/056,187

(22) PCT Filed: Sep. 22, 2009
(86) PCT No.: PCT/US09/57763

§ 371 Date: Jan. 27, 2011

Related U.S. Application Data
(60) Provisional application No. 61/099,282, filed on Sep. 23, 2008.

(51) Int. Cl. H05B 1/00; A47C 7/02; A47C 7/14; A47C 31/00

(52) U.S. Cl. 219/217; 297/452.42; 297/180.1; 297/180.12

(57) ABSTRACT

A seat assembly and a method of controlling temperature of a seat assembly. The seat assembly may include a seat bottom configured to move between a first position and a second position. A flexible duct provides air to the seat bottom. The flexible duct has a housing defining an air passage and a plurality of support members disposed in the air passage. The flexible duct moves when the seat bottom moves from the first position to the second position.

### CROSS-REFERENCE TO RELATED APPLICATIONS

This application claims the benefit of U.S. provisional application Ser. No. 61/099,282, filed Sep. 23, 2008, which is hereby incorporated by reference in its entirety.

### BACKGROUND OF THE INVENTION

1. Field of the Invention

The present invention relates to a ventilated seat assembly and a method of control.

2. Summary of the Invention

In at least one embodiment a seat assembly is provided. The seat assembly has a seat bottom and a flexible duct for providing air to the seat bottom. The seat bottom is configured to move between a first position and a second position. The seat bottom has an air inlet. The flexible duct is fluidly connected to the air inlet and includes a housing and a plurality of support members. The housing defines an air passage and has a first wall and a second wall disposed opposite the first wall. The plurality of support members are disposed in the air passage and extend from the first wall to the second wall. The flexible duct moves when the seat bottom moves from the first position to the second position.

In at least one other embodiment, a method of controlling temperature of a seat assembly is provided. A desired temperature level is determined when the seat assembly is occupied. An amount of heating desired is determined when the desired temperature is indicative of heating. A passive heating strategy is executed to heat air provided to the seat assembly through a flexible duct when the difference between current and desired temperature levels does not exceed a first threshold amount. An active heating strategy is executed to heat air provided to the seat assembly when the difference between current and desired temperature levels exceeds the first threshold amount.

### BRIEF DESCRIPTION OF THE DRAWINGS

FIG. 1 is a perspective view of an exemplary seat assembly.

FIG. 2 is a section view of the seat assembly along section line 2-2.

FIG. 3 is a perspective view of an exemplary flexible duct that may be provided with the seat assembly.

FIGS. 4A-4D are fragmentary section views of embodiments of exemplary flexible ducts.

FIG. 5 is a perspective view of a portion of a flexible duct having a thermal element.

FIG. 6 is a section view of another embodiment of a flexible duct.

FIGS. 7-9 illustrate components and assembly steps for another embodiment of a flexible duct.

FIG. 10 is a flowchart of an exemplary method of controlling temperature of the seat assembly.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

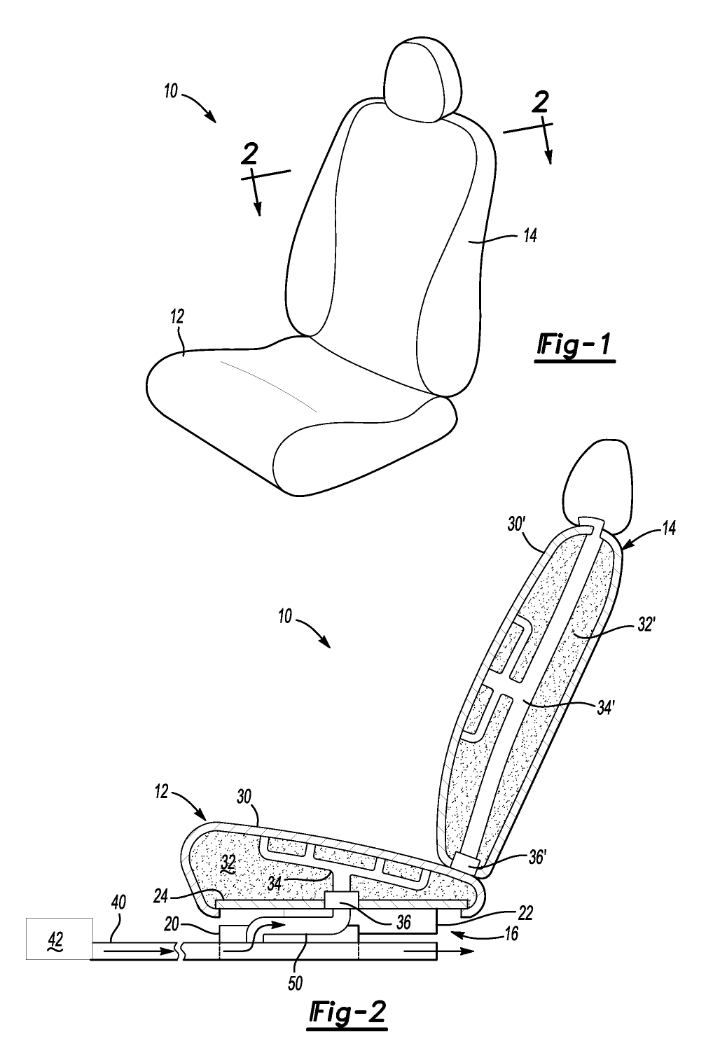

Referring to FIG. 1, an exemplary seat assembly 10 is shown. The seat assembly 10 may be provided with a motor vehicle, such as a car or truck. In addition, the seat assembly 10 may be configured for non-vehicular applications in one or more embodiments.

Referring to FIGS. 1 and 2, the seat assembly 10 may include a seat bottom 12 and a seat back 14. The seat back 14 may be pivotally mounted on the seat bottom 12 in a manner know by those skilled in the art. The seat bottom 12 may be disposed on a track assembly 16 that facilitates fore-aft positioning of the seat assembly 10. For instance, the track assembly 16 may include a lower track 20 and an upper track 22. The lower track 20 may be fixedly disposed on a mounting surface, such as a floor pan of a vehicle. The upper track 22 may be moveably associated with the lower track 20 and may be fixedly coupled to a seat bottom frame 24.

The seat bottom 12 and/or seat back 14 may be configured to provide airflow with respect to an associated seating surface. Such airflow may heat or cool a seat occupant. For example, the seat bottom 12 may include an air permeable trim cover 30 disposed proximate a cushion 32 upon which a seat occupant may be disposed. The cushion may receive, at least partially define, or may be disposed proximate to one or more air passages 34 that provide air to the trim cover 32. A blower 36 may be provided for forcing air through the air passage 34. The blower 36 may be fluidly coupled to the air passage 34 and may be disposed near an inlet of the air passage 34. In addition, the blower 36 may be disposed proximate a support surface, such as the seat bottom frame 24.

The seat back 14 may also be configured to provide airflow with respect to an associated seating surface. For example, the seat back 14 may also include a trim cover 30′, a cushion 32′, one or more air passages 34′, and a blower 36′ similar to that of the seat bottom 12. In addition, the seat back 14 may include an air passage that may have an outlet near the top of the seat back 14 to direct air toward the head and/or neck region of a seat occupant. The air passage 34′ of the seat back 14 may be fluidly connected to the air passage 34 of the seat bottom 12 or a common air supply in one or more embodiments. Alternatively, the blower 36′ may be omitted in embodiments where the seat bottom 12 and seat back 14 are fluidly connected.

In one or more embodiments, a supply duct 40 may be associated with the seat assembly 10. The supply duct 40 may provide air that may be temperature controlled. For example, the supply duct 40 may receive air from a plenum of a heating ventilation and cooling (HVAC) system 42 that may configured to heat, cool, and/or distribute temperature-controlled air. The supply duct 40 may be dedicated to supplying air to the seat assembly 10 or may also have additional outlets, such as for providing air to a rear passenger area of a vehicle. The supply duct 40 may be made of a polymeric material like polypropylene and may have a predetermined fixed shape. Alternatively, the supply duct 40 may not be connected to the HVAC system 42 and receive air from the surrounding environment in one or more embodiments.

Referring to FIG. 2, a flexible duct 50 may be provided to fluidly couple the seat assembly 10 to the supply duct 40. As such, the flexible duct 50 may flex to accommodate movement of the seat assembly 10 with respect to the supply duct 40 while maintaining airflow through the flexible duct 50. For instance, the flexible duct 50 may include a first end that is coupled to an outlet of the supply duct 40 and a second end disposed opposite the first end that provides air to the seat bottom 12 and/or seat back 14. In the embodiment shown, the second end of the supply duct 40 is coupled to the blower 36. In addition, the flexible duct 50 may be provided elsewhere in the seat assembly 10. For instance, a flexible duct may be provided that fluidly connects the seat bottom 12 and the seat back 14. In addition, a flexible duct may make up at least a portion of one or more air passages 34, 34′ in the seat back 12 and/or seat bottom 14. The flexible duct 50 may also facilitate installation and packaging in or to the seat assembly 10.

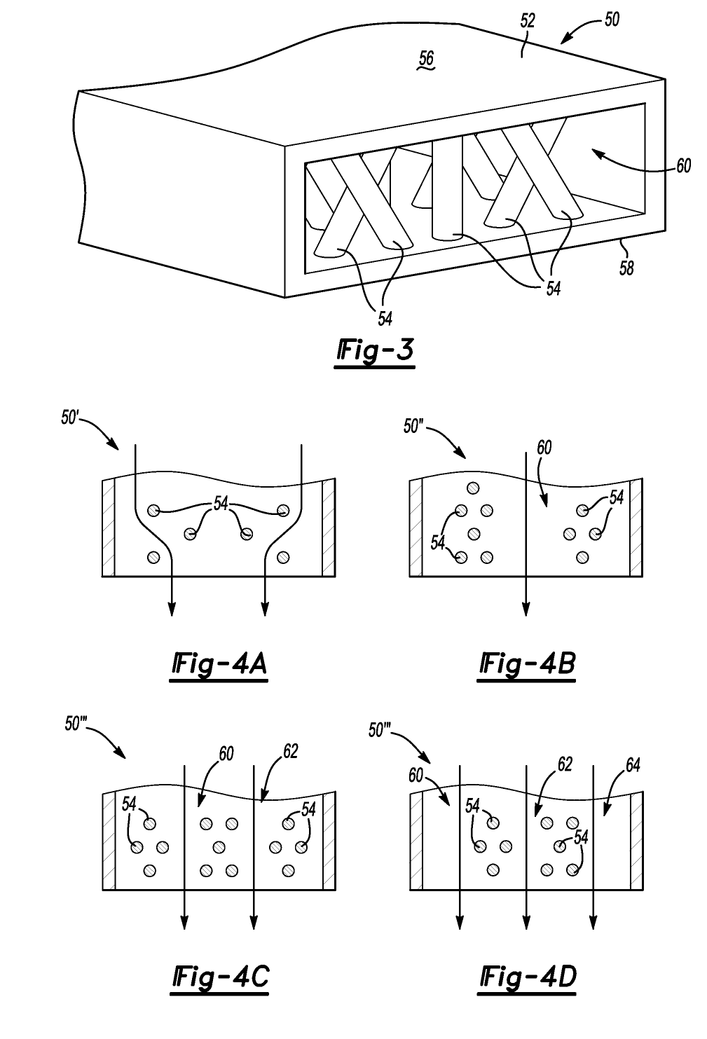

Referring to FIG. 3, a portion of an embodiment of a flexible duct 50 is shown. The flexible duct 50 may include a housing 52 and a plurality of support members 54. The housing 52 may be made of a flexible material that inhibits airflow. For instance, the housing may be made of a tight knit or high thread density fabric, a polymeric film, or combinations thereof. The support members 54 may extend between opposing first and second walls 56, 58 of the housing 52 to help maintain a space or air passage 60 between the first and second walls 56, 58 that facilitates airflow. In one or more embodiments, at least a portion of the first and second walls 56, 58 may be disposed substantially perpendicular to each other. The support members 54 may be made of any suitable material, such as polymeric fibers. The support members 54 may be disposed substantially perpendicular to the first and second walls 56, 58 and/or at an angle with respect to the first and second walls 56, 58 in one or more embodiments.

Referring to FIGS. 4A-4D, various configurations of flexible ducts are shown. In these embodiments, support members are represented by circles for simplicity. However, it is to be understood that the support members may be provided in perpendicular or non-perpendicular orientation to their respective housings in each embodiment.

In FIG. 4A, the flexible duct 50′ has support members 54 that may be provided in a random or non-clustered configuration to distribute support of the housing 52. As such, airflow generally weaves around the support members as represented by the arrowed line.

In FIG. 4B, the flexible duct 50″ has support members 54 that are clustered into two groups or rows that may extend between the first and second ends or openings of the flexible duct 50″. The two groups or rows may be spaced apart from each other, thereby providing a passage 60 between. Such a configuration may provided increased airflow due to the absence of support members 54 in the passage while providing support near the walls of the housing 52.

In FIG. 4C, the flexible duct 50′ has support members 54 that are clustered into three groups or rows that may extend between the first and second ends or openings of the flexible duct 50′. The three groups or rows may be spaced apart from each other, thereby providing first and second passages 60, 62 therebetween. Different groups of support members may be clustered near the walls of the housing 52 similar to the embodiment shown in FIG. 4B.

In FIG. 4D, the flexible duct 50″ has support members 54 that are clustered into two groups or rows that may extend between the first and second ends or openings of the flexible duct 50″. The two groups or rows may be spaced apart from each other and spaced apart from the walls of the housing 52, thereby providing first 60, second 62, and third 64 passages. The first and third passages 60, 64 may be disposed adjacent to the walls of the housing 52, which may provide increased airflow as compared to the embodiment in FIG. 4C.

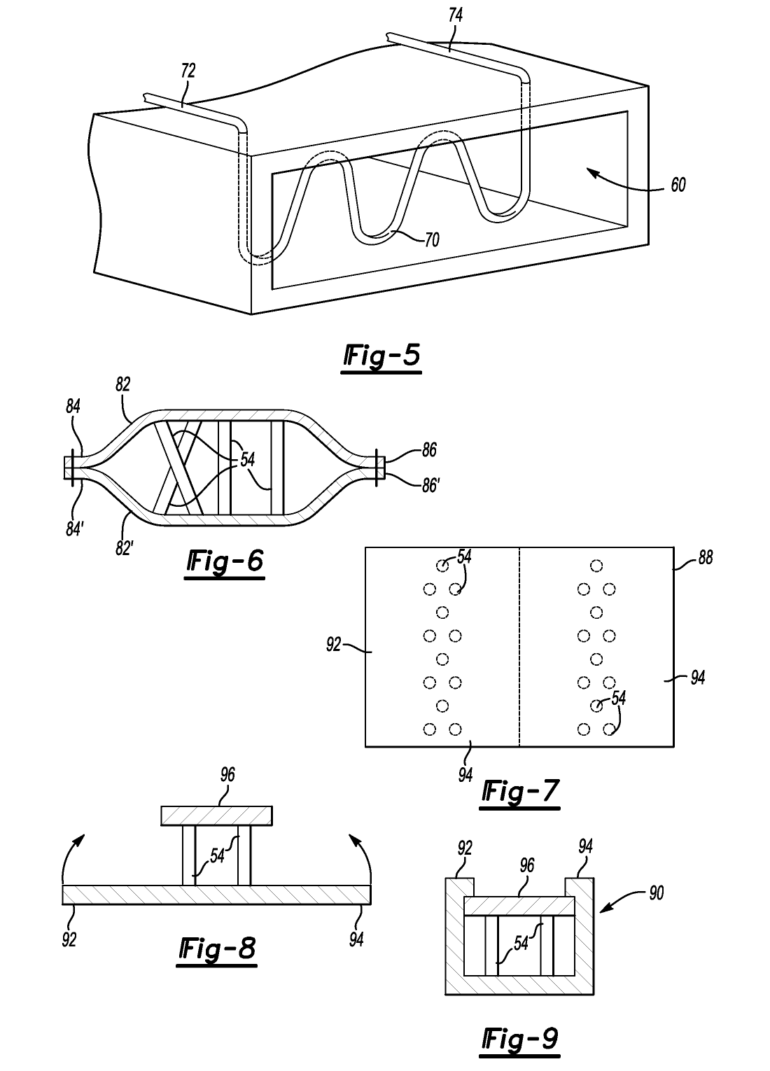

Referring to FIG. 5, one or more flexible duct embodiments may be provided with a material or thermal element 70 with temperature altering characteristics, such as the ability to heat and/or cool air near or within the duct. For instance, a flexible duct may be provided with a thermal element 70 for heating air that flows through the flexible duct. In the embodiment shown, the support members are omitted for clarity. The thermal element 70 may be an electrically conductive wire that provides heat air flowing in the flexible duct when an electric current is provided. In addition, the thermal element may be configured as a Peltier device that can provide heating and cooling. The thermal element 70 may be provided near an end of the flexible duct and may be coupled to a power supply for a blower. The thermal element 70 may be made of a different material than the housing and support members and may have a serpentine configuration that may be disposed in the air passage 60. The thermal element 70 may also include first and second end portions 72, 74 that extend through the housing and may extend against, along, or may be integrated with the housing of the flexible duct.

Referring to FIGS. 6-9, embodiments of flexible ducts having two piece housings are shown. These embodiments may have support members having perpendicular and/or non-perpendicular configurations as previously described.

In FIG. 6, the flexible duct 80 has a first panel 82 and a second panel 82′. The first and second panels 82, 82′ may each have first and second end portions 84, 84′ and 86, 86′, respectively, that may be disposed opposite each other. A plurality of support members 54 may extend between the first and second panels 82, 82′ and may be disposed near a center portion of the first and second panels 82, 82′ and spaced apart from the first and second end portions 84, 84′, 86, 86′. A gap or air passage may be provided between the first and second panels 82, 82′ by coupling the opposing end portions of the first and second panels 82, 82′ together. For instance, first end portions 84, 84′ of the first and second panels 82, 82′ may be coupled together and second end portions 86, 86′ of the first and second panels 82, 82′ may be coupled together. The end portions 84, 84′, 86, 86′ may be coupled in any suitable manner, such as by stitching or with an adhesive.

In FIG. 7, an exemplary subassembly 88 is shown. The subassembly 88 may be a sheet that may form a first panel 82 or a second panel 82′ or combinations thereof. The subassembly 88 may be cut into separate pieces along the dashed line to form at least a portion of a panel or housing. Alternately, the subassembly 88 may not by cut to provide various flexible duct configurations, such as those having multiple air passages like those shown in FIGS. 4B-4C. As shown, the subassembly may have regions that are free of support members.

Referring to FIGS. 8 and 9, another embodiment of a flexible duct 90 is shown. This embodiment may be made using a subassembly 88 or a portion thereof. For example, the subassembly 88 in FIG. 7 may be cut along the dotted line into separate pieces. In FIG. 8, a representative piece of the subassembly 88 is shown. Opposing ends 92, 94 of the subassembly may be folded up and attached to each other or attached to a top panel 96, if provided, to form the flexible duct.

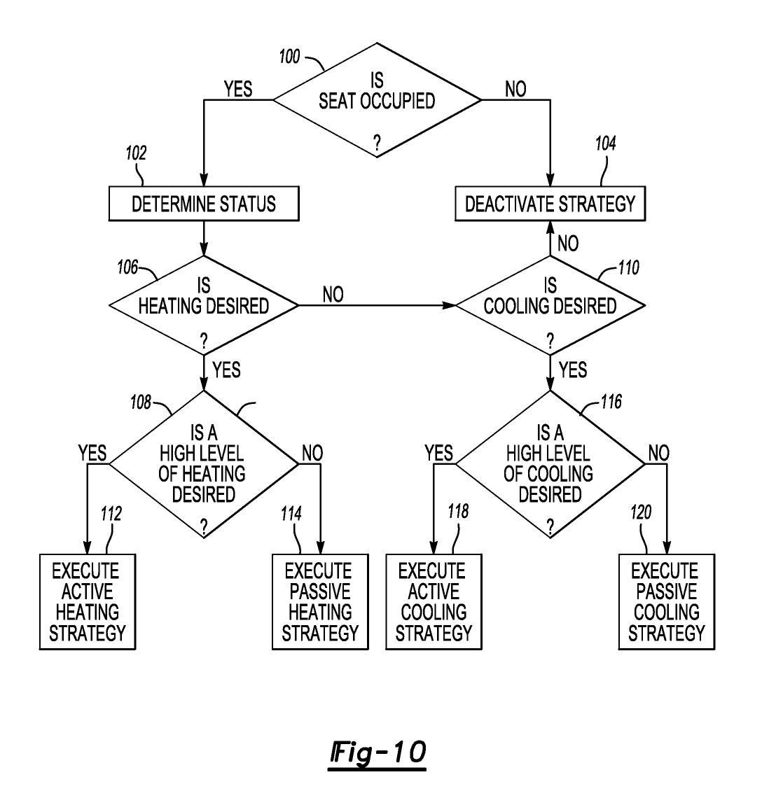

Referring to FIG. 10, and exemplary method of control is shown. One or more method steps may be omitted or performed in different sequences in various embodiments. The method steps may be executed by one or more controllers, which may or may not be associated with the HVAC system 42. In addition, one or more method steps may be include heating or cooling profile data indicative of the thermal output characteristics of the duct. Such profile data may be used to smooth the transition between temperature levels and/or modes to provide temperature adjustments that are less noticeable to a seat occupant.

At 100, the method begins by determining whether an occupant is present in one or more seat assemblies. In the case of a driver's seat, the method may presume that the seat assembly 10 is occupied when the vehicle ignition is turned on or whenever the methodology is executed. An occupant may be detected in various ways, such as through mass detection, proximity sensors, thermal sensors, and the like. If an occupant is detected, the method may proceed to block 102. If an occupant is not detected, the method may proceed to block 104 where the method may be deactivated for the seat assembly 10.

At 102, the method determines or receives the status of comfort related variables, such as the current ambient temperature, HVAC output temperature, and temperature level desired by a seat occupant. The desired temperature level may be based on a user input to the HVAC control system and/or a seat temperature control selector.

At 106, the method determines if heating is desired. Heating may be desired based on an input provided by a seat occupant, such as activation of a button or switch used to activate or increase a seat heating level. In addition, an input may be based on a request to activate or increase the heat output of the HVAC system 42. If heating is desired, the method continues at block 108. If heating is not desired, the method continues at 110.

At 108, the method determines the amount of additional heating desired. The amount of additional heating desired may be based on a comparison between a current temperature level and a desired temperature level. If the difference between the current and desired temperature levels exceeds a threshold value, then a high amount of heating may be desired and the method continues at block 112. If the difference between the current and desired temperature levels does not exceed a threshold value, then a low amount of heating may be desired and the method continues at block 114.

At 112, an active heating strategy may be executed. Active heating may include providing heated air from the HVAC system 42 to the seat assembly 10 and activation of the thermal element 70 of the flexible duct to heat air passing within.

At 114, a passive heating strategy may be executed. Passive heating may include providing heated air from the HVAC system 42 to the seat assembly 10 and not activating the thermal characteristics of the duct to further heat the air passing within. A low amount of heating may be provided to maintain a desired temperature level once such a level is achieved.

Returning to block 110, the method determines if cooling is desired. Cooling may be desired based on an input provided by a seat occupant, such as activation of a button or switch used to activate or increase a seat cooling level. In addition, an input may be based on a request to deactivate or decrease the heat output of the HVAC system 42. If cooling is desired, the method continues at block 116. If cooling is not desired, the method is deactivated at 104.

At 116, the method determines the amount of additional cooling desired. The amount of additional cooling desired may be based on a comparison between a current temperature level and a desired temperature level. If the difference between the current and desired temperature levels exceeds a cooling threshold value, then a high amount of cooling may be desired and the method continues at block 118. If the difference between the current and desired temperature levels does not exceed a cooling threshold value, then a low amount of cooling may be desired and the method continues at block 120.

At 118, an active cooling strategy may be executed. Active cooling may include providing cooled air from the HVAC system 42 to the seat assembly 10 and activation of the thermal element 70 of the flexible duct to cool air passing within.

At 120, a passive cooling strategy may be executed. Passive cooling may include providing cooled air from the HVAC system 42 to the seat assembly 10 and not activating the thermal element 70 of the flexible duct to further cool the air passing within. A low amount of cooling may be provided to maintain a desired temperature level once such a level is achieved.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A seat assembly comprising:
a seat bottom configured to move between a first position and a second position, the seat bottom having an air inlet; and
a flexible duct fluidly connected to the air inlet for providing air to the seat bottom, the flexible duct including:
a housing defining an air passage, the housing having a first wall and a second wall disposed opposite the first wall; and
a plurality of support members disposed in the air passage and extending from the first wall to the second wall;
wherein the flexible duct moves when the seat bottom moves from the first position to the second position.

2. The seat assembly of claim 1 wherein the first and second walls are made of fabric.

3. The seat assembly of claim 1 wherein the seat bottom further comprises a blower mounted to a seat bottom frame and wherein the flexible duct is coupled to the blower.

4. The seat assembly of claim 1 wherein a center portion of the first wall is disposed substantially parallel to a center portion of the second wall.

5. The seat assembly of claim 1 wherein first and second end portions of the first wall are disposed against first and second end portions of the second wall, respectively.

6. The seat assembly of claim 1 wherein first and second end portions of the first wall are stitched to first and second end portions of the second wall, respectively.

7. The seat assembly of claim 1 wherein the first and second walls are configured as mirror images of each other and the plurality of support members are disposed in a row.

8. The seat assembly of claim 1 wherein the plurality of support members are disposed in first and second rows that are spaced apart from each other to form the air passage.

9. The seat assembly of claim 1 wherein the flexible duct includes a thermal element disposed proximate an end of the flexible duct, wherein the thermal element is configured to change the temperature of air flowing through the flexible duct.

10. The seat assembly of claim 9 wherein the thermal element is a wire having a serpentine portion disposed in the air passage and has first and second ends that extend along an exterior surface of the housing.

11. A method of controlling temperature of a seat assembly, comprising:
determining whether the seat assembly is occupied;
determining a desired temperature level when the seat assembly is occupied;
determining whether the desired temperature level is indicative of heating;
determining an amount of heating desired when the desired temperature is indicative of heating;
executing a passive heating strategy to heat air provided to the seat assembly through a flexible duct when the difference between current and desired temperature levels does not exceed a first threshold amount; and
executing an active heating strategy to heat air provided to the seat assembly through the flexible duct when the difference between current and desired temperature levels exceeds the first threshold amount.

12. The method of claim 11 wherein the active heating strategy includes activating a thermal element in the flexible duct to provide heat.

13. The method of claim 11 wherein the passive heating strategy includes not activating a thermal element in the flexible duct to provide heat.

14. The method of claim 11 wherein the passive heating strategy includes providing heated air from an HVAC system to the flexible duct.

15. The method of claim 11 further comprising determining whether the desired temperature level is indicative of cooling when the desired temperature level is not indicative of heating.

16. The method of claim 15 further comprising determining an amount of cooling desired when the desired temperature is indicative of cooling.

17. The method of claim 16 further comprising executing a passive cooling strategy to cool air provided to the seat assembly through a flexible duct when the difference between current and desired temperature levels does not exceed a second threshold amount; and
executing an active cooling strategy to cool air provided to the seat assembly through a flexible duct when the difference between current and desired temperature levels exceeds the second threshold amount.

18. The method of claim 17 wherein the passive cooling strategy includes providing cooled air from an HVAC system to the flexible duct.

19. The method of claim 17 wherein the active cooling strategy includes activating a thermal element in the flexible duct to remove heat.

20. The method of claim 11 further comprising deactivating the method of control when the seat assembly is not occupied and when heating and cooling are not desired.
